(19) United States
(12) Patent Application Publication
(10) Pub. No.: US 2025/0066008 A1
(43) Pub. Date: Feb. 27, 2025

(54) SOLAR HOT AIR BALLOON VENT

(71) Applicant: ARIZONA BOARD OF REGENTS ON BEHALF OF THE UNIVERSITY OF ARIZONA, Tucson, AZ (US)

(72) Inventors: Michael Debbins, Tucson, AZ (US); Tristan Schuler, Tucson, AZ (US); Davis Goolsby, Tucson, AZ (US); Joshua Crest, Tucson, AZ (US); Jekan Thangavelautham, Tucson, AZ (US)

(21) Appl. No.: 18/724,159

(22) PCT Filed: Jan. 5, 2023
(86) PCT No.: PCT/US2023/060157

§ 371 Date: Jun. 25, 2024

Related U.S. Application Data
(60) Provisional application No. 63/306,207, filed on Feb. 3, 2022.
(60) Provisional application No. 63/296,746, filed on Jan. 5, 2022.

(51) Int. Cl. B64B 1/44; B64B 1/64

(52) U.S. Cl. CPC B64B 1/44; B64B 1/64

(57) ABSTRACT

Solar balloons are a simple and lightweight option for aerial exploration and meteorological data collection both terrestrially and on other planets. By using lightweight materials that absorb visual light and emit low levels of thermal radiation, solar balloons behave similarly to hot air balloons but can ascend to much higher altitudes. Unlike hot air balloons, which use an onboard heat source to raise the temperature of the internal air, solar balloons generate heat by absorbing solar radiation, providing a free source of lift and eliminating the need for carrying an extra tank of lighter-than-air gas or fuel. The solar balloons of the present invention include mechanical vents on the tops of the balloons to store and release hot air. Using these mechanical vents, the balloons can adjust altitude to enter regions of the atmosphere with different wind flows, which can lead to horizontal controllability of the platform.

### CROSS-REFERENCES TO RELATED APPLICATIONS

This application claims benefit of U.S. Provisional Application No. 63/296,746 filed Jan. 5, 2022, and U.S. Provisional Application No. 63/306,207 filed Feb. 3, 2022, the specifications of which are incorporated herein in their entirety by reference.

### STATEMENT REGARDING FEDERALLY SPONSORED RESEARCH OR DEVELOPMENT

This invention was made with government support under Grant Nos. 80NSSC19M0197 and 80NSSC20K0687 awarded by NASA. The government has certain rights in the invention.

### FIELD OF THE INVENTION

The present invention relates to devices and methods for controlling the altitude of solar hot air balloons. More specifically, the present invention relates to mechanical vents designed for controllably releasing air from solar hot air balloon envelopes.

### BACKGROUND OF THE INVENTION

Weather balloons, also known as sounding balloons, are the most common type of high-altitude balloon. The envelope material for weather balloons is typically made from an elastic latex and filled with helium. These types of balloons are also used for radiosondes, which are released from over 2000 locations worldwide daily. Radiosondes ascend to altitudes of up to 40 km and carry a payload that includes sensors that measure temperature, humidity, pressure, and wind speeds. Radiosondes are instrumental in providing data for predicting weather forecasts.

There are two major types of long-duration high-altitude balloons with altitude adjustment capabilities. Super pressure and zero-pressure balloons are usually filled with helium or hydrogen and the envelopes are made from a lightweight linear low-density polyethylene (LLDPE) film. Zero-pressure balloons are typically inflated with helium, and when the balloon reaches a desired float altitude, excess helium is released out of a valve at the bottom of the balloon. These balloons typically float for 1-2 weeks. On the other hand, super-pressure balloons are inflated with a lower amount of helium than needed for full inflation and the gas pressurizes and inflates the balloon once the desired float altitude is reached. Super pressure balloons, also known as pumpkin balloons or ultra-long duration balloons (ULDBs), can fly for up to 100 days. FIGS. 1A and 1B show a comparison of a zero pressure and a super pressure balloon.

Solar high-altitude balloons (SHABs) are a special type of hot air balloon that incorporates a lightweight envelope that absorbs solar radiation to heat internal air and generate lift. These balloons can climb to the lower stratosphere on Earth and will fly as long as the sun is above the horizon, or even longer in the case of IR balloons, which may fly night and day. Dozens of solar balloon flights are conducted every year, carrying scientific payloads investigating low-frequency sound transmission in the stratosphere and capturing aerosol levels above the tropopause. They have been used on Earth to validate means of detecting seismic activity on Venus using sound, and have been proposed as flight systems in their own right for both Mars and Venus due to their simplicity and lack of requirement for a lifting gas.

Infrared (IR) balloons, also known as Infrared Montgolfiere, have been implemented similarly to SHABs. Specifically, the National Centre for Space Studies (CNES) carried out a multitude of experiments with IR balloons in the 1970s. In their early forms, IR balloons were quite large and required helium to reach their initial altitude since not enough heat could be generated on the ground. More recent experiments have been carried out in Sandia. Similarly to SHABs, IR balloons incorporate a lightweight material for absorbing heat but rely primarily on Infrared radiation reflected from the earth's surface instead of direct solar radiation from the sun, allowing IR balloons to fly at night as well as during the day.

### BRIEF SUMMARY OF THE INVENTION

It is an objective of the present invention to provide systems, devices, and methods that allow for altitude control of solar hot air balloons, as specified in the independent claims. Embodiments of the invention are given in the dependent claims. Embodiments of the present invention can be freely combined with each other if they are not mutually exclusive.

In some aspects, the solar high-altitude balloon vents of the present invention allow for the release of heated air at the command of a computer or remote control. These vents are actuated by a servo motor that opens and closes to release or retain air from within the balloon envelope. By controlling the release of heated air from within the balloon, the altitude of the balloon could be adjusted at will. This control of altitude then offers the possibility of lateral control limited by the force of the wind. Winds tend to blow in different directions at different altitudes, and thus, by selecting the proper altitude, the balloon may hitch a ride on the winds at that altitude in a desired direction. This could be utilized to have the balloon blow with the wind, using no propulsion, to any destination of choice. The possibility of keeping stationary above a certain point on the ground or executing a desired flight path is also possible, given desirable winds.

The present invention has a huge potential to offer a high-altitude research and commercial platform, that fills the gap between maneuverable aircraft at low altitudes, and long-duration satellites in space. With the potential to keep balloons (e.g. IR balloons) in the stratosphere for weeks at a time in any location, at a very low cost, the potential applications for communications, observations, and atmospheric research are boundless.

One of the unique and inventive technical features of the present invention is the use of a controllable vent to selectively retain and release hot air from the envelope of a solar high-altitude balloon. Without wishing to limit the invention to any theory or mechanism, it is believed that the technical feature of the present invention advantageously provides for altitude control and even some degree of horizontal control of a solar high-altitude balloon. None of the presently known prior references or work has the unique inventive technical feature of the present invention.

Furthermore, the inventive technical feature of the present invention contributed to a surprising result. One of normal skill in the art would expect that the implementation of a two-way vent would be most useful for controlling the altitude and horizontal position of a solar hot air balloon. Surprisingly, the presently claimed invention implements a one-way vent capable of releasing hot air, or retaining it, and is capable of efficient solar balloon altitude control. Thus, the technical feature of the present invention is counterintuitive because it contributed to a surprising result.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWINGS

The features and advantages of the present invention will become apparent from a consideration of the following detailed description presented in connection with the accompanying drawings in which:

FIG. 1A shows a photograph of a zero-pressure balloon at float altitude.

FIG. 1B shows a photograph of a super-pressure balloon at float altitude.

FIG. 2A shows an image of the internal inspection of a BlackSHAB envelope.

FIG. 2B shows an image of the internal inspection of a SHAB4-V envelope.

FIG. 3A shows a side view of a SHAB Styrofoam gondola.

FIG. 3B shows a top view of a SHAB Styrofoam gondola with internally mounted electronics.

FIG. 4 shows a block diagram of a SHAB gondola and its vent electronics architecture.

FIG. 5A shows a schematic drawing of a hot air balloon parachute vent, which is a balloon altitude control mechanism.

FIG. 5B shows a schematic drawing of a Google Loon umbrella valve, which is a balloon altitude control mechanism.

FIG. 6 shows an image of a SHAB envelope that ripped during a tethered experiment to test parachute vent feasibility.

FIG. 7 shows a table of material properties for potential structural vent materials.

FIG. 8A shows a butterfly valve expanded polystyrene (EPS) vent prototype for top-mounting on a SHAB envelope.

FIG. 8B shows a 1-flap-1-servo EPS vent prototype for top-mounting on a SHAB envelope.

FIG. 8C shows a 2-flap-2-servo EPS vent prototype for top-mounting on a SHAB envelope.

FIG. 9A shows a top-down view of a flapping EPS vent in a closed configuration.

FIG. 9B shows a top-down view of a flapping EPS vent in an open configuration.

FIG. 10A shows a photograph of a 6 meter charcoal-coated clear elastic SHAB envelope design.

FIG. 10B shows a photograph of a 3 meter charcoal-coated clear elastic SHAB envelope design.

FIG. 10C shows a photograph of a 6 meter black plastic SHAB envelope design.

FIG. 11 shows a graph of altitude profiles for standard 6 meter spherical charcoal-coated clear plastic SHAB envelopes. Balloon D4P7 was towed aloft using a weather balloon, and then released and allowed to sink to its neutral buoyancy altitude.

FIG. 12 shows a graph of altitude profiles for 3 meter charcoal-coated clear plastic SHAB envelopes.

FIG. 13 shows photographs of the progressive failure of a 10 meter prototype due to excessive stress on the envelope

FIG. 14 shows a graph of altitude profiles for black plastic SHAB envelopes.

FIG. 15 shows a photograph of a recovered melted black polyethylene SHAB envelope after a flight.

FIG. 16 shows a graph of altitude profiles for vented 6 meter charcoal-coated clear plastic SHAB envelopes.

FIG. 17 shows another block diagram of a SHAB gondola and its vent control architecture.

FIGS. 18A-18B show photographs of a SHAB envelope with a controllable vent, with a man, included for scale.

### DETAILED DESCRIPTION OF THE INVENTION

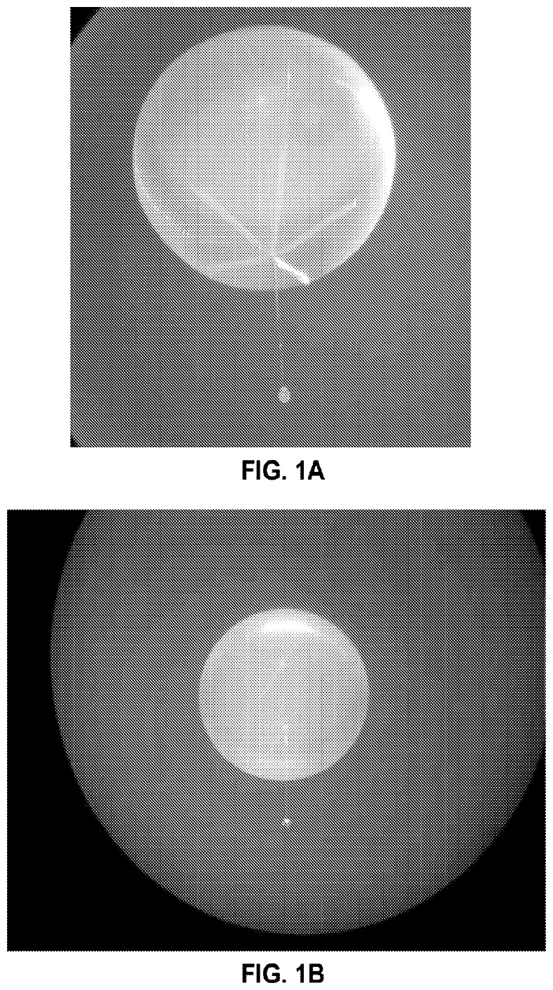

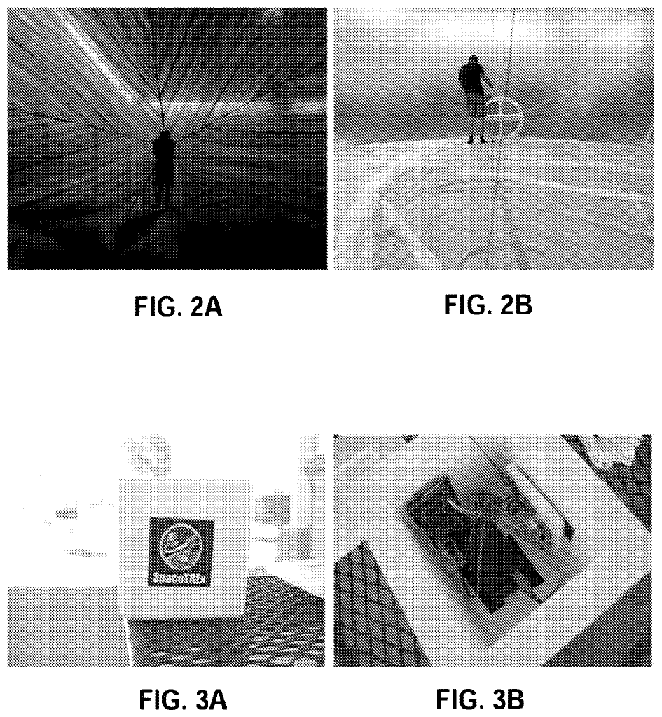

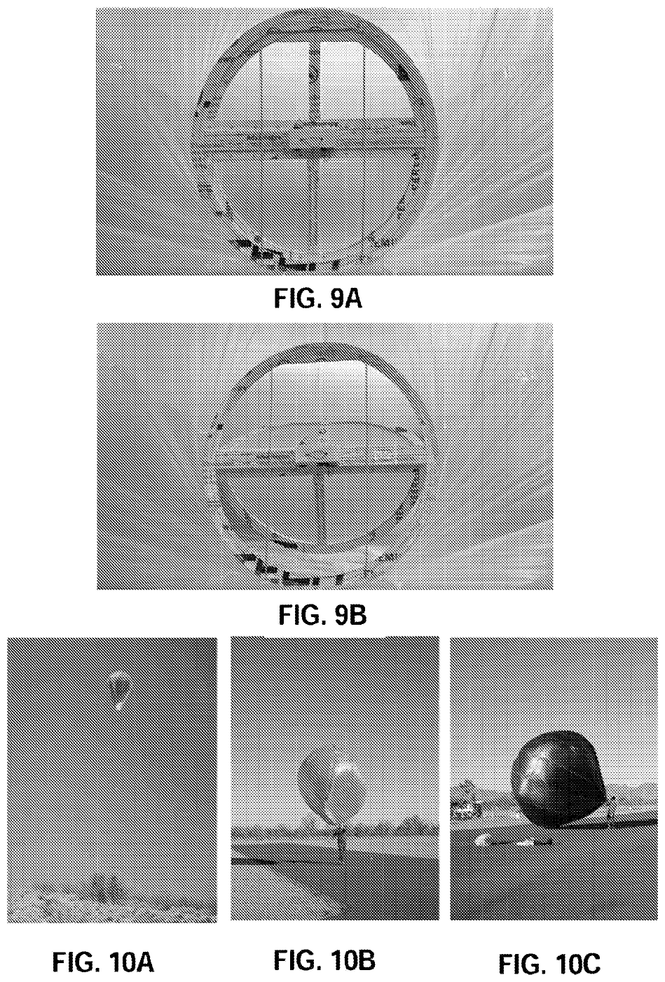

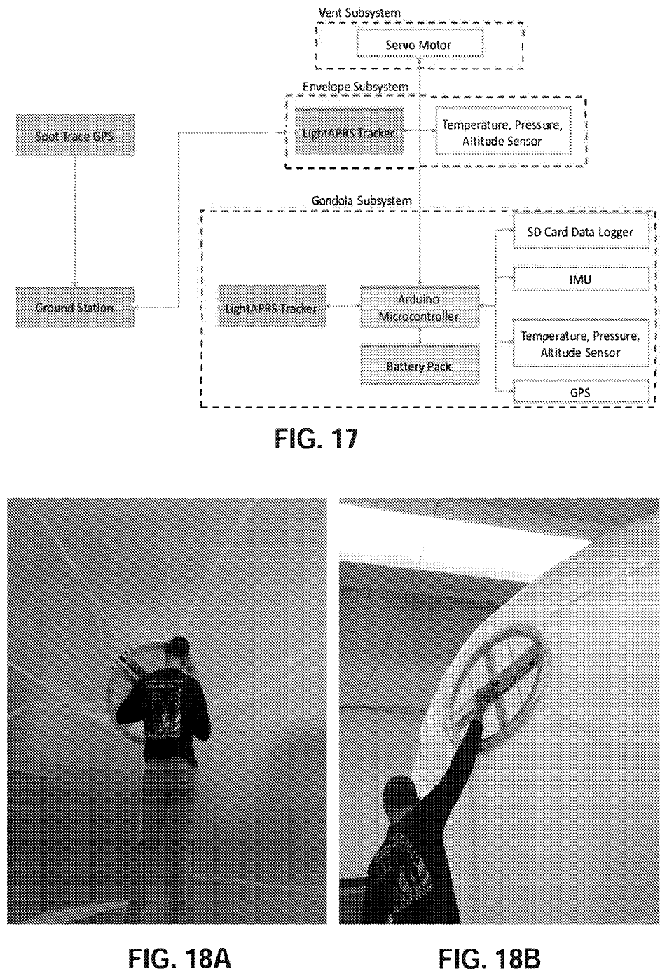

Referring now to FIGS. 1A-18B, the present invention features solar high-altitude balloons which include controllable one-way vents to allow for the retention and release of hot air from the balloon envelopes.

In some embodiments, an altitude-controllable solar high-altitude balloon may include an envelope; one or more controllable vents in the envelope; and a control system for controlling the vent. In preferred embodiments, control of the vents may provide altitude control of the balloon. As a non-limiting example, opening the vents may increase the release of hot air from the envelope, thereby decreasing the buoyancy of the balloon, and closing the vents may decrease the release of hot air from the balloon, thereby increasing the buoyancy of the balloon.

The control system may operate to control the operation of the vents. As a non-limiting example, the control system may provide power to an actuator to open or close the vents based on an algorithm or a command transmitted from a surface station. In some embodiments, the control system may include a power supply, a controller, a wireless communication device, onboard sensors for control and telemetry (e.g. timer, altimeter, ground link), and a GPS tracker. In some embodiments, the wireless communication device may be capable of Bluetooth, infrared, Satellite Iridium, LoRa, or any other form of wireless communication with the controllable vent. This may allow for communication of the balloon's position to a ground station and reception of instructions based on the position. In some embodiments, the control system may include a microprocessor and instructions for automatically opening and closing the vents based on measured variables. Part or all of the control system may be positioned inside an insulated gondola suspended from the balloon.

In some embodiments, the balloon may be an infrared (IR) balloon configured to fly night and day. The controllable vents may be more open during the day than at night, to reduce daily altitude variations. The balloon may share data with one or more additional balloons and may control its altitude based on data from the one or more additional balloons. As a non-limiting example, a fleet of balloons may each ascend to a different altitude by maintaining a different vent position, each balloon may measure wind velocity at that altitude and share the data with the fleet, and each balloon may then change its vent position to reach a desired altitude based on the compiled data from the fleet. In another embodiment, a single balloon may sample wind velocities through an altitude range (e.g. 50,000-70,000 ft) before selecting an altitude within the range with a suitable wind velocity for a desired flight plan.

In preferred embodiments, the balloon may be designed to operate at an altitude above 35,000 feet. In some embodiments, the balloon may be designed to operate at an altitude of about 50,000-70,000 feet. The vents may be operated to maintain an altitude in a desired range, for example, above or below 35,000, 40,000, 45,000, 50,000, 55,000, 60,000, 65,000, or 70,000 feet. In some embodiments, the balloon may be designed to operate at any altitude from ground level up to around 70,000 feet.

The vents may be controlled from the balloon or a ground station. In other embodiments, the vents may be controlled via a timer. As a non-limiting example, a simple timer may close the vents during hours corresponding to night and open the vents during hours corresponding to the day. In preferred embodiments, the vents may be positioned at the center top of the envelope, off-center at the top of the envelope, or a combination thereof. In other embodiments, multiple vents may be attached to a single envelope. An envelope may have opposing vents at the top and bottom of the envelope or may have multiple vents in the upper half of the envelope.

In some embodiments, the present invention features one or more controllable vents for a solar high-altitude balloon. As a non-limiting example, the vents may include a frame base configured for attachment to an envelope of a solar hot air balloon, where the rim surrounds a vent area; one or more hinged flaps, each configured to cover at least a portion of the vent area; and one or more motors, coupled with the flaps so that actuation of the motor or motors is configured to open or close the flaps, thereby controlling the vent. In preferred embodiments, the vents provide altitude control of a solar high-altitude balloon. In some embodiments, this altitude control provides for horizontal control of the balloon.

As another non-limiting example, the controllable vents for a solar high-altitude balloon may include: a frame base having a circular shape (or other suitable shapes, such as an octagon) with semi-circular (or any other suitable shape) cut-outs on either side of a central support member; one or more flaps attached via flap hinges to the central support member or the outer rim of the frame base, and one or more servo motors, mounted on the central support member and linked to each of the flaps via a plurality of pushrods such that actuation of the motor is configured to open or close the flaps, thereby controlling the vent. In some embodiments, the number of pushrods scales with the number of flaps. Each flap may include a flap frame having a semi-circular shape slightly larger than the semi-circular cut-outs and a flap coating, attached over the flap frame. In embodiments where the flaps do not have cut-outs, a flap coating may be unnecessary.

In some embodiments, the flaps are configured to open upwards or downwards into the envelope of the balloon. The vents may be designed such that air pressure within the envelope presses the flaps closed until they are forcibly opened by the motor. The vents may additionally include a power supply, mounted on the central support member or connected to the servo motor by a longer wire. In some embodiments, the power supply may be positioned in a suspended gondola.

The vents may additionally include an electronic module configured to communicate instructions to the servo motor. As a non-limiting example, the electronic module may include a wireless receiver to receive wireless instructions for the positioning of the vent, and actuate the servo motor accordingly.

The vents may be secured to an envelope of a high-altitude balloon via tape, glue, cement, heat-sealing, or welding. The frame base may include expanded polystyrene (EPS), Expanded Polypropylene (EPP), balsa wood, basswood, carbon composite, glass composite, rigid plastic, or metal. The flap coating and an envelope of the balloon may be constructed with the same material, such as thin plastic or cloth. The flap hinges may be made from tape, cloth, or plastic, or may be made using rigid hinges with pins.

In some embodiments, the frame base may have a diameter of about 0.3 meters to about 2 meters. In other embodiments, the frame base may have a diameter larger than 2 meters. In some embodiments, the frame base may have a diameter of at least 1/10th of a diameter of an envelope of the balloon. In other embodiments, the frame base may have a smaller diameter. In some embodiments, the frame base diameter will be approximately the same diameter as, or slightly larger than the vent diameter. The vents may be designed to allow the balloon to increase or decrease altitude at a rate of up to about 600 feet per minute. As a non-limiting example, the vents may allow the balloon to increase or decrease altitude at a rate between about 0-600 feet per minute.

In some embodiments, the vents may include one or more support rods crossing over the cut-outs. In preferred embodiments, the flaps may be partially opened to various positions between a fully-open position and a fully-closed position. The vents may also include one or more control wires between the servo motor and a control module. In some embodiments, the control module may be positioned below an envelope of the balloon (e.g. in a suspended gondola).

In some embodiments, the present invention features a method for controlling the altitude of a solar high-altitude balloon. As a non-limiting example, the method may include: providing a solar high-altitude balloon having a controllable vent; determining an altitude of the balloon; and selectively opening and closing the vents to retain or release hot air from the balloon, thereby increasing or decreasing the balloon altitude to a desired altitude. In some embodiments, the vents may be opened slowly to avoid a rapid change in temperature and buoyancy.

As another non-limiting example, a method for controlling the altitude of a solar high-altitude balloon may include: at least partially opening a controllable vents to release air from an envelope of the balloon to decrease an altitude of the balloon, and at least partially closing the controllable vents to retain air within the envelope to increase an altitude of the balloon.

In some embodiments, the present invention features a method for controlling the horizontal position of a high-altitude balloon. As a non-limiting example, the method may include: providing a solar high-altitude balloon having a controllable vent; determining an altitude of the balloon; determining wind velocities at multiple altitudes; and selectively opening and closing the vents to retain or release hot air from the balloon, thereby increasing or decreasing the balloon altitude to an altitude having a wind velocity that will direct the balloon towards a desired horizontal position. This method may allow the balloon to follow a desired flight path such as a holding pattern or a transverse pattern. In some embodiments, the holding pattern may have a radius of fewer than 10 miles. In other embodiments, the holding pattern may have a radius of less than 1, 2, 3, 4, 5, 6, 7, 8, 9, 11, 12, 13, 14, 15, 16, 17, 18, 19, 20 25, 30, 35, 40, 45, or 50 miles. The wind velocity at various altitudes may be determined by direct measurement, GPS positioning data, weather balloon data, or a combination thereof. In some embodiments, a fleet of balloons may share data to determine wind velocities at various altitudes.

### Example

The following is a non-limiting example of the present invention. It is to be understood that said example is not intended to limit the present invention in any way. Equivalents or substitutes are within the scope of the present invention.

### Solar High-Altitude Balloons (SHAB) as a Long Duration Controllable Aerial Platform

Solar balloons are a simple and lightweight option for aerial exploration and meteorological data collection both terrestrially and on other planets. By using a lightweight material that absorbs visual light and emits low levels of thermal radiation, solar balloons behave similarly to hot air balloons but can ascend to much higher altitudes. Unlike hot air balloons, which use an onboard heat source to raise the temperature of the internal air, solar balloons generate heat by absorbing solar radiation, providing a free source of lift and eliminating the need for carrying an extra tank of lighter-than-air gas or fuel. Recently, solar balloons have gone through many technological advancements, ranging from design to material selection to controllability. This example discusses the results and progress of new experimental solar balloon designs that explore various envelope sizes and material selection as well as a mechanical vent design on the top of the balloon to store and release hot air. By including a mechanical vent, the balloons can adjust altitude to enter regions of the atmosphere with different wind flows, which can lead to horizontal controllability of the platform.

### Solar Balloon Envelope Construction

The solar balloon envelopes were constructed from the heliotrope design by Sandia National Laboratories. The initial solar balloon envelopes were constructed from 0.31 mil, 400×12 ft. rolls of clear high-density plastic sheeting. The sheets were then cut into 30 ft. long sections, folded, and a curve following equation (1) was used to cut out the gore pattern of the balloon in the material.

$$w = \frac{c}{2 n} cos cos ( 2 π \frac{l}{c} ) \qquad ( 1 )$$

where w is the width measured from the fold axis along the center of the gore, c is the circumference of the balloon envelope, n is the number of gores desired, and l ranges from 0 (the center of the gore) to c/4.

After the gores were cut, they were sealed together using strips of Scotch shipping tape until a giant spherical ball was constructed, sealed on both ends. Next, a hole was cut on one of the “ends” of the ball and reinforced with a paracord, creating the intake hole for the solar balloon. Next, guy lines were tied around the paracord at each seam of the balloon and connected to a main line that would later connect to the gondola.

Prior to darkening the envelope, the balloon is inflated and inspected for small holes. During the construction process, and because of defects in the plastic as manufactured, dozens of small holes can form in the material and are sealed from the inside of the envelope with small pieces of scotch tape. While inflated the temperature probes can also be mounted and hung from the top of the balloon or the vent. For vented solar balloons, two safety lines were connected from the vent to the parachute guy lines using 10 m of nylon cord in case of a gore seam tape failure. FIGS. 3A-B show the inspection of two alternate design SHAB envelopes.

The final step of envelope construction was to darken the clear plastic material. This was done using pyrotechnic grade air float charcoal powder; the fine powder sticks to the inside of the envelope without the need for adhesives. This step can be very messy and was also performed outside in areas where there was a wind block to prevent unwanted inflation of the solar balloon. The reason the charcoal-coated plastic balloons are used for the standard design instead of using black polyethylene is due to the scarcity of lightweight black plastic in large rolls. Because one of the key ingredients of charcoal powder is carbon, the fine powder coats and darkens the material, improving solar absorption properties. The hypothesis is that, by coating the entire envelope with an ultra-fine layer of these carbon nanoparticles, the balloon will have superior solar absorption properties compared with (1) the clear and black polyethylene plastics or (2) a germanium aluminum alloy coating proposed by JPL. Similarly, carbon nanoparticles have been proposed as a method for producing solar thermal steam propulsion for interplanetary travel.

Unfortunately, the exact optical properties of the two different envelope materials have not been measured at this time. However, estimates can be made from experiments conducted by NASA and the Naval Research Laboratory for common materials. In these experiments, the solar absorption of the material was measured with a spectrometer with an integrating sphere attachment, and the normal infrared emittance of the materials was measured using an infrared spectrometer with an attached heated cavity. Black polyethylene had a solar absorptivity of 0.93 and an emissivity of 0.92. Clear polyethylene has an absorptivity of 0.835 and emissivity of 0.165. Therefore, the charcoal-coated material has optical properties somewhere between the clear and black polyethylene. An ideal balloon envelope material would have an absorptivity of 1 and emissivity of 0, converting all incident solar irradiation to heat without losing any energy to the environment.

### Gondola

For terrestrial flight experiments, the bare minimum payload required for tracking is a satellite GPS tracker and an Automatic Packet Reporting System (APRS) transmitter. APRS is a protocol within the amateur radio community (ham) that allows for real-time GPS tracking over 1-minute intervals at 144.39 MHz in the U.S. (different countries have different frequencies reserved for APRS traffic). APRS transmitters for high-altitude balloon flights require longer antennas than typical APRS transmitters to communicate with the ground networks from high altitudes. These solar balloons used the StratoTrack APRS transmitter from High Altitude Science which is specifically designed for high-altitude balloons. The tracker records atmospheric temperature, pressure, and device voltage, and includes an unlocked GPS for tracking at high altitudes; many commercial GPS modules do not work above 18 km, above which solar balloons can fly. The StratoTracker relies on line-of-sight (LOS) communication with nearby ground radio towers, while the APRS transmitters are unreliable near the Earth's surface. Real-time tracking dropped out a few kilometers in elevation above the landing location on each solar balloon flight. Therefore, a satellite GPS tracker was also necessary, with the primary use being for retrieval of the balloons after landing.

The Spot Trace is a popular GPS tracker in the high-altitude balloon community for locating weather balloons after they land. They can also be used as a real-time tracker but can be unreliable and do not update as often as APRS transmitters. On one flight the Spot Trace did not update for the duration of the flight until the balloon landed. Also, lithium-ion batteries should be used for any powered systems on the balloon due to the extreme temperatures (a lesson learned the hard way after the first flight).

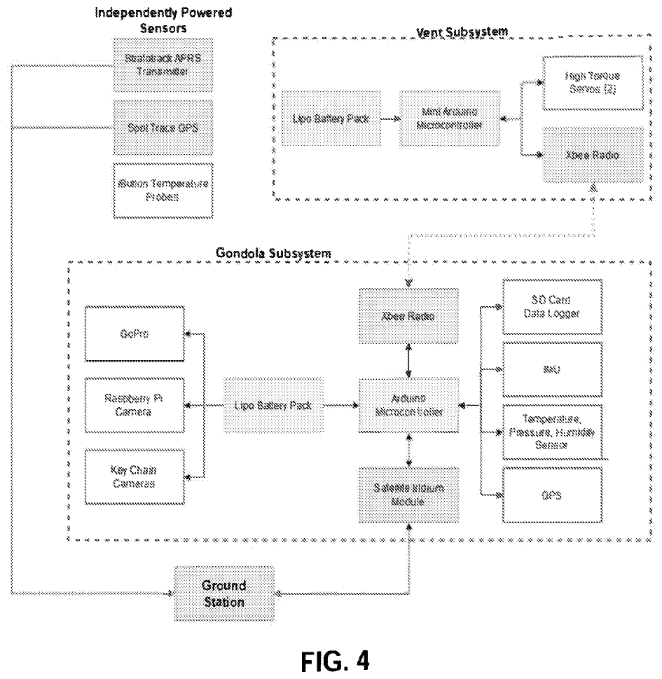

For heavier payloads, Styrofoam coolers were used to mount and insulate all the electronics as shown in FIGS. 4A-Bs. The main gondola setup consisted of an Arduino Mega, IMU, altimeter, temperature sensors, GPS, XBee radio, Spot Trace, and an Iridium satellite module. Cameras in the gondola and small temperature probes inside the envelope were also included on a few flights (the temperature probes were never recovered). FIG. 4 displays a block diagram of the standard electronics architecture for the SHAB missions. The IMU, GPS, and meteorological sensors can be used for control algorithms and the Iridium satellite module can be used for remotely controlling the balloons or manual override of the autonomous balloons. The Iridium satellite module used was the RockBlock 9607; it works from anywhere in the world, at any altitude, and requires both a line rental to activate and credits for sending and receiving 50-byte messages. An XBee pair was used to control the vent at the top of the balloon via 2.4 GHz radio.

### Balloon Control Methods

Three main methods balloons are used in industry to adjust the altitude of balloons (not including blimps or zeppelins which use propellers and a weight-shifting keel-like structure). High-altitude balloons use two methods depending on whether they are zero-pressure or super-pressure balloons. Zero-pressure balloons do not necessarily control their altitude, but they have a vent at the bottom of the balloon to release excess gas and prevent the balloon from bursting when rising to higher altitudes. Additionally, zero-pressure balloons descend only after reaching their highest altitude as the material degrades and gas starts leaking.

Super-pressure balloons (ultra-long duration balloons, or ULDBs), are completely sealed and filled with a pre-calculated amount of helium to provide positive lift. Because these balloons are sealed, as they rise, the internal pressure expands and displaces more ambient air, eventually realizing a float altitude. Until recently, these ULDBs have been used as free-flying balloons to perform science missions on the edge of space, but several companies have modified the design to incorporate controllability.

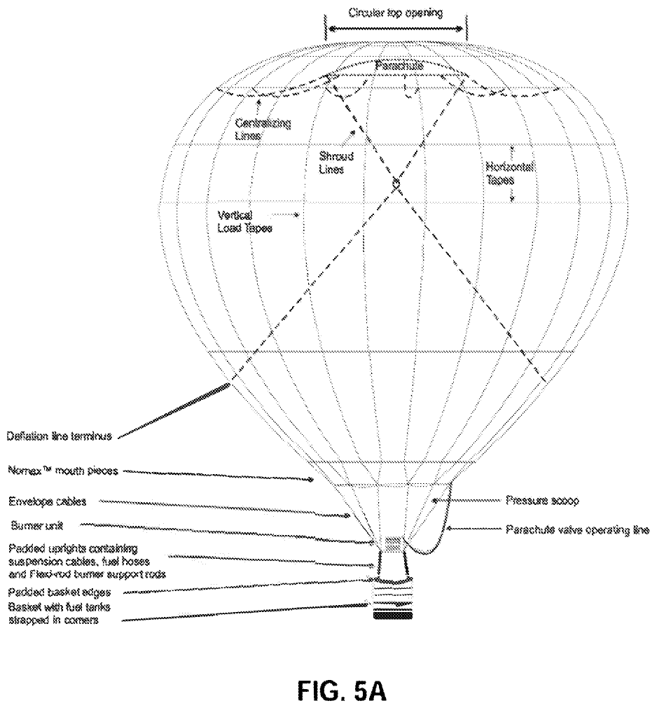

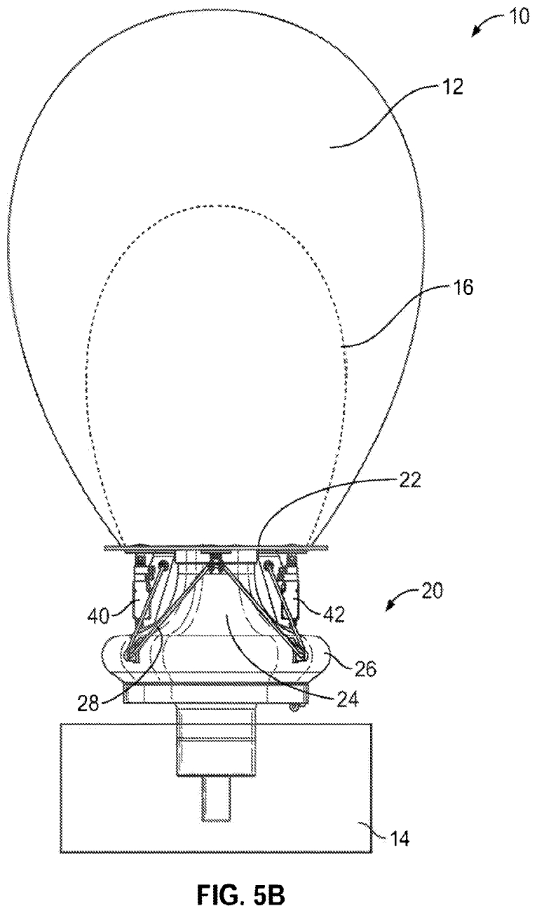

Both Google Loon and Worldview are developing high-altitude balloon systems that loiter in place. Google designed these balloons to provide cell coverage all over the world, whereas Worldview is more interested in capturing high-quality imagery. These companies have patents that involve using a pump to add or remove air into the system, thus changing the amount of buoyancy. Google's patent has the bladder inside of the super-pressure balloon whereas Worldview uses a combination of zero-pressure and super-pressure balloons and pumps air in and out of the super-pressure balloon. Since the solar balloon has an opening at the bottom to allow for ram-inflation and natural degassing, these pumping devices will not work without a method for sealing and unsealing the bottom valve. Hot air balloon pilots use a parachute valve to adjust altitude while in flight, as well as for rapidly deflating the balloon while grounded. The parachute consists of a large circular piece of fabric at the top of the balloon, and a pulley system that connects the vent to the upper walls of the balloon envelope as well as a control line down to the pilot's basket as shown in FIG. 5A. The vent is opened by the pilot pulling the control line, which compresses the upper walls of the envelope and allows the vent to drop into the balloon, thus letting hot air escape out of the top of the balloon.

### Vent Design

Designing a vent for a solar balloon is somewhat uncharted territory. There has been mention of a vented solar balloon from NASA's Jet Propulsion Laboratory in the 1990s; however, they provided no documentation revealing how the vent was constructed. Due to the complex nature of flexible inflated envelope materials, as well as the many unknown atmospheric variables the balloons can experience while in flight, an agile prototyping process was used to design a vent for solar balloon applications.

### Parachute Vent Feasibility Experiment

For larger solar balloons with a more durable material, a parachute vent could be a good option. However, with a more durable material also comes added weight, and therefore less lifting force. Before installing a parachute vent in a solar balloon, a tethered balloon test was conducted to assess the feasibility of a typical vent design on a fragile material.

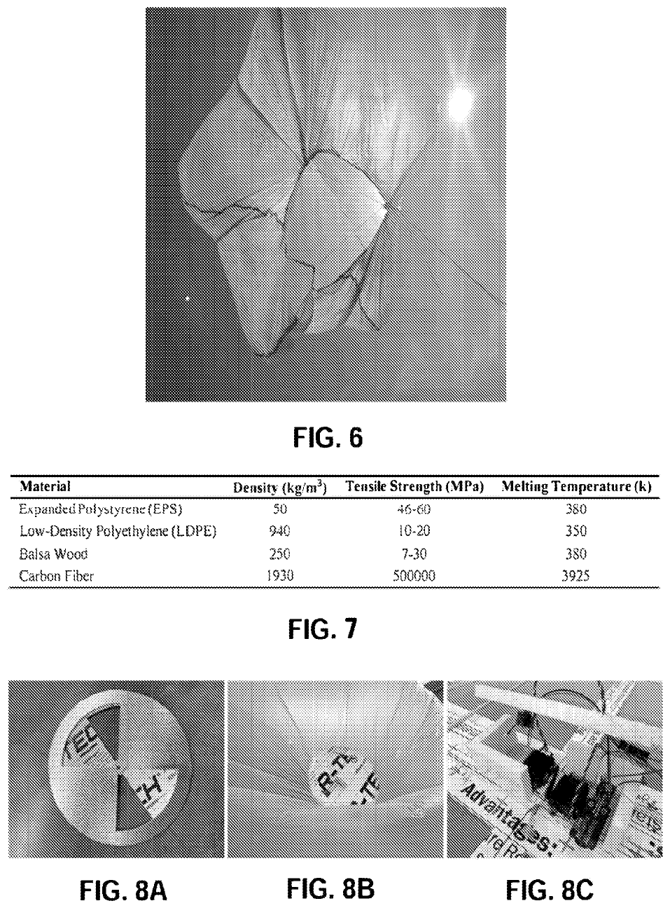

For the tethered test, a solar balloon was filled manually with air and allowed time for it to heat up and produce lift. The five guy lines connected to the balloon's intake hoop were then tied to a main line and attached to a counterweight on the ground. Within minutes, three of the five guy lines ripped the envelope material due to the high lift force as shown in FIG. 6. After this experiment, the polyethylene was deemed too fragile to incorporate a miniaturized parachute vent system for solar balloon prototypes.

### Standard 6 Meter Spherical SHAB Flights

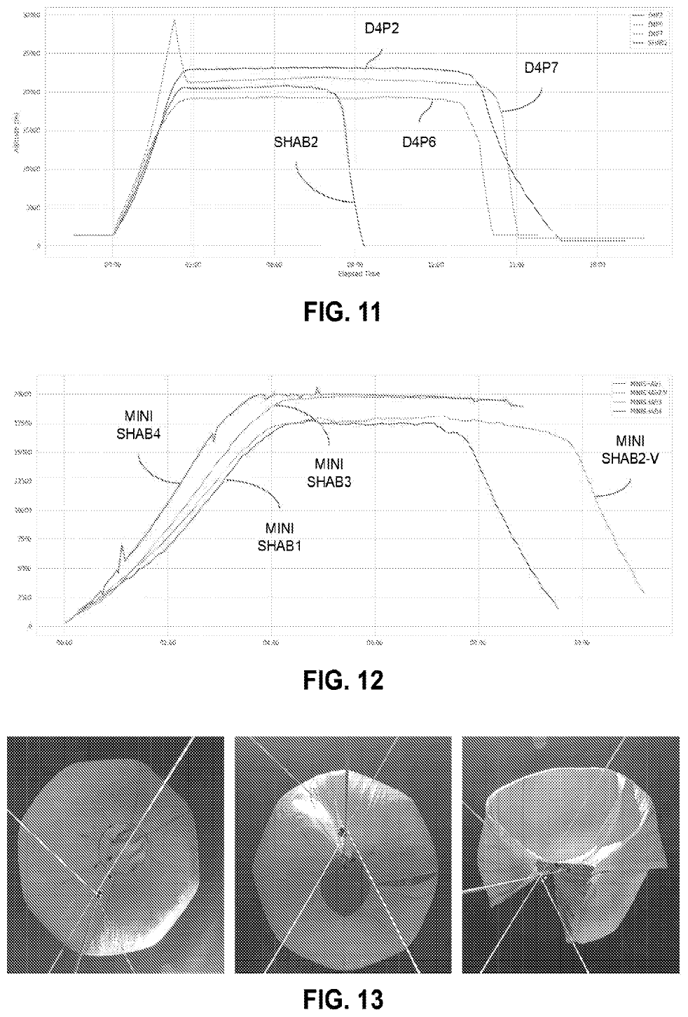

FIG. 11 shows the altitude profiles of a sample of standard 6 m charcoal-coated spherical SHAB envelopes, including a “grand slam” solar balloon flight. The grand slam design features a standard solar balloon that is attached to a weather balloon and released when the weather balloon bursts, showing the feasibility of ram-inflating solar balloons from a higher altitude, which could help with solar balloon missions on Mars or Venus.

On average, the standard SHAB designs have ascent rates between 1-3 m/s and descent velocities between −3 to −8 m/s. These standard solar balloons usually float between 19 km and 23 km depending on payload weight which has ranged between 0.5 and 3 kg. The float duration also ranges depending on the season when the balloon is deployed; SHAB2 was launched in the fall of 2020, whereas the other 3 balloons were launched in the summer of 2020. Once a float altitude is reached, the balloons can oscillate between a few hundred meters. These oscillations have been recorded with high-altitude weather balloons as well and have been hypothesized to be caused by gravity waves. Additionally, the intake hoop at the bottom of the solar balloon could contribute to the oscillations due to complex heat transfer and fluid flow that can occur in that region of the balloon.

### Scaled Size SHAB Flights

In addition to the standard 6 m diameter SHAB Envelopes, experiments were conducted with scaled-size versions of the standard 6 m design. The 3 m scaled size balloons were dubbed MiniSHAB envelopes. These envelopes were constructed with the same methods as the standard SHAB envelopes, with the measurements scaled to result in a half-sized envelope. As depicted in FIG. 12, the MiniSHAB envelopes had slower times to climb to float altitude, taking about four hours to reach the float. They acquired lower float altitudes than the standard SHAB envelopes, floating between 17.5 km and 20 km. Both of these effects can be attributed to the smaller size of the envelope, which directly impacts the amount of buoyant lift the envelope can produce in comparison to its surface area. With ⅛th the lifting volume of a standard SHAB envelope, the balloons have a much smaller payload capacity. However, the advantage of the MiniSHAB envelopes is their ease of construction. A MiniSHAB envelope takes approximately ⅓rd the construction time and requires only ¼th the material of a standard SHAB envelope.

Four MiniSHAB flights were flown. MiniSHAB 1 was a proof of concept, flown to show that a smaller solar balloon can fly with a light enough payload. This balloon reached a float altitude of only 17.5 km, less than the standard balloons. MiniSHAB 2V was flown with a scaled vent, to experiment with using a vent on 3 m envelopes. It flew successfully, but no significant vent action was noted. This was most likely due to the small size of the vent, which was unable to release enough heated air to significantly change the balloon's altitude. The small size of the vent was necessary to keep the system mass low enough to fly; therefore, vented MiniSHABs with the same mechanical vent design are not feasible.

MiniSHAB 3 and 4 were experiments to test if a miniaturized version of the Montgolfier Infrarouge Balloon (MIR) developed by CNES is feasible; MIR balloons absorb infrared radiation in addition to solar radiation to continue to fly at night. MiniSHAB 3 was a standard charcoal coated 3 m envelope as a base case to compare against MiniSHAB 4. MiniSHAB 4 was an adaptation of a MIR balloon, with the bottom half of the balloon coated in charcoal, and the top half coated in aluminum powder to mimic the metalized mylar used in the Infrared Montgolfier. By capturing IR radiation emitted by the ground, and using this energy to heat the internal air, the balloon can theoretically stay aloft at night, without direct solar radiation. Both MiniSHAB 3 and 4 used an extremely light solar-powered tracker payload, to maximize their float altitude and the likelihood of success for the infrared balloon envelope. The balloons were launched on the same day, within a half hour of each other, to ensure a fair comparison between the standard MiniSHAB and infrared MiniSHAB. These two balloons reached a similar float altitude of 20 km and maintained this altitude for the entire day. However, after sunset, both balloons quickly descended to the ground. This does not invalidate the concept of the infrared balloon. However, it shows that the MiniSHAB is likely too small to fly at night using IR radiation. Additionally, unlike activated charcoal powder, the metal powder did not adhere well to the polyethylene envelope, which is another likely factor for not staying afloat at night.

Sandia National Laboratories also conducted a series of test flights using 10 m diameter balloons, but found that they were unreliable—either terminating before level flight was achieved, or floating lower than expected. The cause was determined to be excessive stress on the balloon envelope, which opened longitudinal tears along the lower half of the balloon, as seen in the upward camera footage in FIG. 13. In most cases, these tears then propagated upward, resulting in catastrophic failure at altitudes between about 8 and 14 km. In some instances, the tears did not terminate the flight, but the excessive hot air loss through them resulted in low float altitudes. Efforts are underway to redesign these larger envelopes to better accommodate the higher stress levels.

### Black Plastic SHAB Flights

BlackSHAB1 was constructed using 1 mil black polyethylene and manufactured into the same 6 m sphere heliotrope design mentioned above. The black balloon envelope weighed 3 kg due to the thicker material instead of 1.25 kg like the same sized charcoal coated clear polyethylene balloons. Due to the heavier envelope, a stripped payload including only 2 GPS trackers was flown.

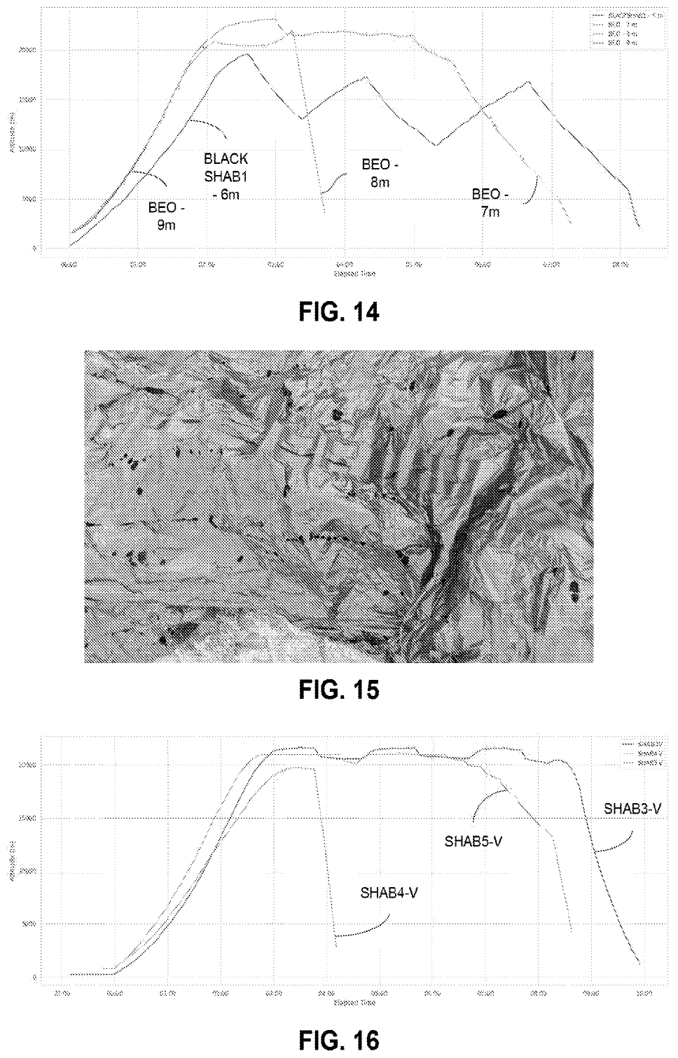

During the flight, the balloon experienced a strange phenomenon where a float altitude was never achieved as seen in FIG. 14. Instead, the balloon rose and fell several kilometers three times throughout the flight. Unfortunately, this balloon landed in the mountains of New Mexico and could not be recovered to inspect the envelope. It was hypothesized that the balloon may have rolled upside down during flight, allowing solar balloon opening to release hot air at a faster rate. Another hypothesis is that the tape lost and regained adhesion during the flight; both SHAB3-V and SHAB4-V had missing gore seaming tape upon recovery.

Sandia National Laboratories also conducted a series of test flights with 0.7 mil photodegradable black plastic envelopes, with sizes ranging from 6 m to 9 m in diameter. Flight performance was variable, with most balloons landing of their own accord before sunset, but one remaining aloft until terminated via geofence. All of the Sandia test balloons showed signs of the black plastic melting during the flight, as shown in FIG. 15. However, this doesn't explain how the BlackSHAB1 balloon regained lift twice instead of leading to an early landing. In any case, more testing is needed to determine whether solar balloons constructed from commercially-available black plastic can sustain nominal, level flight in the lower stratosphere.

### Vented SHAB Flights

FIG. 16 shows the trajectories of the three vented SHAB flights. SHAB3-V used the smaller single-flap prototype described in Section IV and SHAB4-V used the larger double-flap design. The goal of both vents was to demonstrate commanding the SHAB to new altitudes. SHAB3-V was successful in remotely commanding an altitude change via the Iridium satellite network. However, the small vent allowed only a 1 km variance in float altitude with the vent fully open. SHAB4-V included a larger vent that unfortunately failed after its initial opening. In this experiment, the vent was commanded to open instantaneously which resulted in the balloon falling apart, most likely due to the rapid change in temperature and buoyancy. Subsequent vented SHAB flights corrected this issue by opening the vent at a reduced rate. Neither of these first two vents were recovered for post-analysis (the first vent fell off during ascent, and the second vent got stuck high in a tree) but the balloon envelopes were able to be examined and showed gore seaming tape missing. There were no signs of rips or stretches in the envelope material. The hypothesis for why the balloons experienced this phenomenon was that the tape fell off after sunset when the balloon experienced sudden cold temperatures followed by record-high wind speeds of over 100 mph. The most likely explanation for these instances is inadequate construction methods. Future vented balloon flights used stronger tape and higher quality control during construction, preventing this issue from recurring. Future development will also consider alternative gore seaming techniques besides tape, possibly glue or heat sealing.

SHAB5-V opened the vent in a succession of angles and showed that reaching a variety of altitudes using the vent is possible. The vent was able to open in increments, which resulted in large altitude changes. The commanded angle increments were first increased and then decreased to show the balloon was able to descend to an altitude and then re-ascend back to the same float altitude. Next, the angle increments were increased again to allow the balloon to descend in steps, which eventually led to the balloon descending to the ground in a semi-controlled manner (as the balloon got closer to the ground, the dynamic pressure from descent increased enough to collapse the balloon envelope). This flight showed the feasibility of using the vent to achieve a variety of altitudes, with a controllability range between 13 km and the maximum float altitude. This experiment demonstrated the feasibility of future research into further altitude control using the vents. This balloon was unable to be recovered as well, and thus no analysis was possible on the envelope or vent.

The final significant vented balloon flight was SHAB6-V. This balloon did not yield any significant data on the vent performance because it behaved like a standard free SHAB flight. This balloon flew directly over a thunderstorm, and the updrafts and downdrafts from that storm created massive altitude changes that completely overpowered any altitude changes from the vent. However, this balloon did fly over the storm safely, continued to fly into the evening as normal, and was also recoverable. While this flight did not provide any data on vent performance, it revealed that SHABs can traverse over extreme weather, with no harm to the balloon or payload, and only moderate disruption to the altitude profile. This balloon also set a vented SHAB altitude record of 24,243 m, pushed up by updrafts from the thunderstorm.

The recovery of SHAB6-V also allowed for examination of a vent after flight. FIGS. 18A-18B show the vent after removal from the balloon envelope (the balloon envelope is generally tattered and shredded after landing, from dragging along the ground after impact). The vent is largely in the same shape as when constructed, but the Styrofoam is somewhat distorted and weakened. This is hypothesized to occur because, at high altitudes, the low air pressure causes gas to escape from the closed-cell foam. Once the balloon descends, the increasing air pressure crushes down the foam, now depleted of internal gas, causing it to weaken and buckle during descent. This results in the vent being non-reusable, but it still performs satisfactorily in flight (the increased altitude of SHAB6-V is not hypothesized to significantly increase this effect beyond the normal float altitude of the balloons).

The ascent speed of the vented balloons was slower than the unvented balloons, about 1-2 m/s, which is understandable considering that the payloads were heavier and the envelope also had extra weight at the top due to the mounted vent. Aerial footage captured from a drone in FIGS. 19A-B also reveals that (at least near the surface) the SHAB envelope shapes were significantly warped during ascent due to the vent at the top of the balloons. Not only did the warping of the envelope reduce the volume of the balloon, but the absorption of solar irradiation would also be affected due to the change in effective area.

### CONCLUSION

This example describes the results and analysis of several new solar balloon designs and materials as well as the results from flight experiments. The MiniSHAB flight experiments show that the solar balloon design can be scaled to handle various-sized payloads. SHABs with black polyethylene are currently unreliable for flight experiments due to the melting plastic, so more materials need to be tested. The vented solar balloon flights show that altitude control of a SHAB is possible. This foundation may provide improvements in SHAB vent durability, controllability, and autonomous control.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

Reference numbers recited herein are solely for ease of examination of this patent application, and are exemplary, and are not intended in any way to limit the scope of the claims to the particular features having the corresponding reference numbers in the drawings.

What is claimed is:

1. An altitude-controllable solar high-altitude balloon (SHAB), the balloon comprising:
a. an envelope;
b. one or more controllable one-way vents in the envelope, wherein the one or more one-way vents are configured to release and retain hot air; and
c. a control system for controlling the one-way vent;
wherein control of the one or more one-way vents is configured to provide altitude control of the balloon.

2. The balloon of claim 1, wherein the control system comprises a power supply, a controller, a wireless communication device, onboard sensors for control and telemetry, and a GPS tracker.

3. The balloon of claim 1, wherein the control system is positioned inside an insulated gondola.

4. The balloon of claim 1, wherein the balloon is an infrared (IR) balloon configured to fly night and day.

5. The balloon of claim 4, wherein the one or more controllable one-way vents are configured to be more open during the day than in the night, so as to reduce daily altitude variations.

6. The balloon of claim 1, wherein the balloon is configured to share data with one or more additional balloons.

7. The balloon of claim 6, wherein the balloon is configured to control its altitude based on data from the one or more additional balloons.

8. The balloon of claim 1, wherein the balloon is configured to maintain an altitude above 35,000 feet.

9. The balloon of claim 1, wherein the balloon is configured to maintain an altitude of about 50,000-70,000 feet.

10. The balloon of claim 1, wherein the one or more one-way vents are configured to be controlled from the balloon or from a ground station.

11. The balloon of claim 1, wherein the one or more one-way vents are configured to be controlled via a timer.

12. The balloon of claim 1, wherein the one or more one-way vents are positioned at a center top of the envelope, off-center at a top of the envelope, or a combination thereof.

13. A controllable one-way vent for a solar high-altitude balloon, the one-way vent comprising:
a. a frame base configured for attachment to an envelope of a solar hot air balloon, wherein the rim surrounds a vent area;
b. one or more hinged flaps, each configured to cover at least a portion of the vent area; and
c. one or more motors, coupled with the one or more hinged flaps so that actuation of the one or more motors is configured to open or close the one or more hinged flaps, thereby controlling the one-way vent;
wherein the one-way vent is configured to release and retain hot air.

14. The one-way vent of claim 13, wherein the one-way vent is configured to provide altitude control of a solar high-altitude balloon.

15. The one-way vent of claim 14, wherein the altitude control provides for horizontal control of the balloon.

16. A method for controlling horizontal position of a high-altitude balloon, the method comprising:
a. providing a solar high-altitude balloon having a controllable one-way vent;
b. determining an altitude of the balloon;
c. determining wind velocities at multiple altitudes; and
d. selectively opening and closing the one-way vent so as to retain or release hot air from the balloon, thereby increasing or decreasing the balloon altitude to an altitude having a wind velocity that will direct the balloon towards a desired horizontal position.

17. The method of claim 16, wherein the balloon follows a desired flight path.

18. The method of claim 17, wherein the flight path is a holding pattern or a transverse pattern.

19. The method of claim 18, wherein the holding pattern has a radius of less than 10 miles.

20. The method of claim 19, wherein wind velocity is determined by direct measurement, GPS positioning data, weather balloon data, satellite remote wind velocity sensing, or a combination thereof.
